(19) United States
(12) Patent Application Publication
(10) Pub. No.: US 2011/0186752 A1
(43) Pub. Date: Aug. 4, 2011

(54) METHOD AND DEVICE FOR DETERMINING THE RATIO BETWEEN THE CONTENTS OF CHLOROPHYLL AND OF A CHROMOPHORE COMPOUND IN A VEGETABLE TISSUE WITHOUT INDEPENDENTLY MEASURING SAID CONTENTS

(76) Inventors: Nicolae Moise, Gif Sur Yvette (FR); Camelia Tinei-Moise, Gif Sur Yvette (FR); Andrei Nicolae Moise, Gif Sur Yvette (FR); Zoran Cerovic, Paris (FR); Yves Goulas, Le Plassis Robinson (FR); Gwendal Latouche, Paris (FR)

(21) Appl. No.: 12/672,929

(22) PCT Filed: Aug. 7, 2008
(86) PCT No.: PCT/FR2008/051479

§ 371 Date: Feb. 10, 2010

(30) Foreign Application Priority Data
Aug. 13, 2007 (FR) 0757056

(51) Int. Cl. G01N 21/64

(52) U.S. Cl. 250/459.1; 250/458.1

(57) ABSTRACT

A method and device for determining the ratio of the contents of chlorophyll and of a chromophorous compound that is non-fluorescent in the band of chlorophyll fluorescence in a plant tissue, without determining the contents. The method includes:
emission of two excitation radiations of chlorophyll fluorescence, one of the excitation radiations being absorbed by the chromophorous compound and the other not,
measurement of the fluorescence radiations induced, the fluorescence radiation induced by the excitation radiation absorbed by the chromophorous compound being measured outside of the absorption spectrum of chlorophyll and the fluorescence radiation induced by the excitation radiation not absorbed by the chromophorous compound being measured within the absorption spectrum of chlorophyll, the ratio of the contents is determined from the ratio of the measured fluorescence radiations. The method can be implemented for measuring an indicator, called NBI (Nitrogen Balance Index), of the nitrogen nutrition of plants.

The present invention relates to a method of optical determination of the ratio of the contents of a chromophorous compound and of chlorophyll in a plant tissue. It also relates to a system implementing said method.

The invention relates more particularly to the optical, non-destructive and in-situ determination of the ratio of the contents of a chromophorous compound and of chlorophyll in a plant tissue.

At present, more and more works are being conducted for characterizing a plant tissue by the content of the various compounds that this plant tissue contains and by the ratio of the contents of certain compounds. For example, several works have shown the advantage, for monitoring nitrogen nutrition, of the ratio of the contents of polyphenols and of chlorophyll in the leaves. See, on this subject, the article by Cartelat et al. published in 2005 in Field Crops Research (91: 35-49) entitled “Optically assessed contents of leaf polyphenolics and chlorophyll as indicators of nitrogen deficiency in wheat (Triticum aestivum L.)”. In fact, these works show that polyphenols or chlorophyll, taken in isolation, vary both along the leaf and as a function of the nitrogen dose supplied. In contrast, the ratio (chlorophyll content)/(polyphenols content) is characterized by regions of stability along the leaf. These works show that this ratio gives better discriminating power of the nitrogen requirement of a plant leaf than the chlorophyll content or the polyphenols content, and is in fact a useful indicator for crop management.

At present, optical determination of the ratio (chlorophyll content)/(polyphenols content) is carried out in the following way: on the one hand, the chlorophyll content is determined, and on the other hand, the polyphenols content is determined, then the ratio of these contents is calculated.

Various methods are known for measuring on the one hand, the polyphenols content, and on the other hand, the chlorophyll content. For measuring polyphenols, the article by Bilger et al. entitled “Measurement of leaf epidermal transmittance of UV radiation by chlorophyll fluorescence” that was published in Physiologia Plantarum (Vol. 101, p. 754-763) describes a measurement method using the screening effect of the polyphenols of the epidermis on the induction of chlorophyll fluorescence. This method consists of measuring the chlorophyll fluorescence of a leaf excited in the ultraviolet, relative to the fluorescence of the same leaf excited in the visible range. As the polyphenols absorb ultraviolet but not visible light, the polyphenols content of the epidermis of the leaf is deduced from the ratio of the two fluorescences. The document FR 2 830 325 (Goulas, Cerovic et al. 2001) describes an instrument (Dualex) that exploits this method with a feedback loop for eliminating the disturbing effects of the variable fluorescence of chlorophyll.

On the other hand, for the optical measurement of chlorophyll, several methods have already been described, based either on absorption, or on fluorescence. For a method based on fluorescence, reference may be made to the article by Lichtenthaler and Rinderle that was published in 1988 in the review “CRC Crit Rev Anal Chem” (Vol. 19 pages 29-85) entitled “The role of chlorophyll fluorescence in the detection of stress conditions in plants”.

However, in all cases, the result is a significant number of sources, hence increased complexity and an increase in the overall dimensions and cost of a system implementing these measurement methods.

A purpose of the invention is to propose a method and a system for determining the ratio of the contents of chlorophyll and of a chromophorous component that is non-fluorescent in the band of chlorophyll fluorescence, which are simpler than the existing methods and systems.

The invention proposes to achieve this aim and overcome the aforementioned problems with a method for determining the ratio of the contents of chlorophyll and of a chromophorous compound in a plant tissue, the chromophorous compound being non-fluorescent in the band of chlorophyll fluorescence. The method according to the invention comprises the following operations:
emission, by a first emitter in the direction of the plant tissue, of optical radiation, called the first excitation radiation, selected so as to be absorbed partially by the chromophorous compound and to induce a first fluorescence radiation of the chlorophyll,
detection, by a first detector, of a portion of the first fluorescence radiation located substantially outside of the absorption spectrum of the chlorophyll,
emission, by a second emitter in the direction of the plant tissue, of optical radiation, called the second excitation radiation, selected so as not to be absorbed by the chromophorous compound and to induce a second fluorescence radiation of the chlorophyll,
detection, by a second detector, of a portion of the second fluorescence radiation located in the absorption spectrum of chlorophyll, and
determination of the ratio of the contents from the ratio of the fluorescence radiations detected.

The method according to the invention thus makes it possible to perform rapid, non-destructive and in-situ determination of the ratio of the contents of chlorophyll and of a non-fluorescent chromophorous compound in a plant tissue. Moreover, the method according to the invention makes it possible to determine the ratio of the contents without having to determine each of the contents of chlorophyll and of chromophorous compound in the plant tissue.

Moreover, in the method according to the invention, determination of the ratio of the contents of a fluorescent chromophorous compound and of a non-fluorescent chromophorous compound in a plant tissue is carried out with fewer emitters or sources. This makes implementation of the method according to the invention simpler than implementation of existing methods.

Advantageously, each detector supplies an electrical signal. The method according to the invention can comprise sampling, by sampling means, of the electrical signal supplied by each of the first and second detectors.

In a first particular version of the method according to the invention, the first and second excitation radiations can be emitted in the form of pulses non-simultaneously.

In this first version, the method according to the invention can comprise synchronization of the emitters and the sampling means in such a way that the sampling of the electrical signal supplied by the first and/or the second detector is carried out when the first and/or the second emitter emits a pulse.

In a second particular version of the method according to the invention, the first and second fluorescence radiations can be emitted in the form of signals modulated at two different frequencies. These signals can be sinusoidal, square-wave signals, or any other shape.

In this second version, the method according to the invention can additionally comprise filtering, at the modulation frequency of the first excitation radiation, of the electrical signal generated by the first detector detecting the first fluorescence radiation and filtering, at the modulation frequency of the second excitation radiation, of the electrical signal generated by the second detector detecting the second fluorescence radiation. Thus, the electrical signals generated by the first detector on the one hand, and by the second detector on the other hand, can be separated by suitable filtering at the modulation frequencies of the first and second excitation radiations respectively.

The method according to the invention can advantageously be applied directly on a plant entity selected from the following list:
a plant leaf,
a tissue from a plant,
a part of a plant, and
a collection of plants.

In fact, the method according to the invention can be applied directly on a tissue from a plant entity such as a plant without having to remove said tissue. Moreover, the method according to the invention can be applied at a fixed or variable distance from the plant tissue.

Within the scope of a non-limiting example:
the chromophorous compound is a compound of the family of polyphenols, or a group of compounds of this family and the wavelength of the first excitation radiation is between 300 and 500 nm. The wavelength of this first excitation radiation can more particularly be 375 nm, and
the wavelength of the second excitation radiation is between 500 and 700 nm. The wavelength of this second excitation radiation can more particularly be 530 nm.

The method according to the invention can be implemented for determining the nitrogen nutrition requirement of the tissue from the ratio of the contents determined. More generally, the method according to the invention can be implemented for monitoring nitrogen nutrition of plants.

According to another aspect of the invention, a system is proposed for determining the ratio of the contents of chlorophyll and of a chromophorous compound in a plant tissue, the chromophorous compound not being fluorescent in the band of chlorophyll fluorescence. The system according to the invention comprises:
a first emitter emitting, in the direction of the tissue, optical radiation, called the first excitation radiation, selected so as to be absorbed partially by the chromophorous compound and to induce a first fluorescence radiation of the chlorophyll,
a first detector performing the detection of a portion of the first fluorescence radiation located substantially outside of the absorption spectrum of chlorophyll,
a second emitter emitting, in the direction of the tissue, optical radiation, called the second excitation radiation, selected so as not to be absorbed by the chromophorous compound and to induce a second fluorescence radiation of the chlorophyll,
a second detector performing the detection of a portion of the second fluorescence radiation located in the absorption spectrum of chlorophyll, and
calculation means for determining the ratio of the contents from the ratio of the fluorescence radiations detected.

The system according to the invention makes it possible to determine the ratio of the contents of chlorophyll and of a chromophorous compound that is non-fluorescent in the band of chlorophyll fluorescence, using only two emitters (or sources) and therefore with fewer sources than the existing systems. The system according to the invention is less complex in execution and moreover is less bulky and is easier to use.

This simplicity arises from the fact that the system according to the invention does not aim to determine each of the contents of chlorophyll and of chromophorous compound in the plant tissue, but only the ratio of said contents.

In the system according to the invention, the emitters and the detectors can be arranged on the same side of the plant tissue.

Advantageously, the system according to the invention can comprise a collimating optical system performing collimation of the first and the second emitter towards the plant tissue and collimation of the first fluorescence radiation towards the first detector and collimation of the second fluorescence radiation towards the second detector.

In one embodiment, the collimating optical system can comprise at least one parabolic or quasi-parabolic reflector positioned in front of this emitter and performing collimation of this emitter in such a way that the radiation emitted by said emitter is focused on the plant tissue.

According to another embodiment, the collimating optical system can comprise:
a first dichroic mirror receiving the first and the second excitation radiation, emitted respectively by the first and the second emitter, in two approximately perpendicular directions and making the first and second excitation radiations collinear,
a second dichroic mirror receiving the first and the second fluorescence radiation coming from the plant tissue in a collinear manner and directing the first and the second fluorescence radiation respectively onto the first and the second detector in two approximately perpendicular directions, and
optical lenses performing collimation of the excitation radiations and collimation of the fluorescence radiations coming from the tissue.

In this embodiment, the excitation radiations and the fluorescence radiations are not collinear. The collimating optical system comprises a first series of optical lenses arranged in front of the emitters and performing collimation of the excitation radiations and a second series of optical lenses arranged in front of the detectors and performing collimation of the fluorescence radiations.

According to yet another embodiment, the collimating optical system can comprise a third dichroic mirror performing:
reflection, towards the plant tissue, of the collinear excitation radiations coming from the first dichroic mirror, and
transmission, towards the second dichroic mirror, of the collinear fluorescence radiations coming from the plant tissue.

In this embodiment, the excitation radiations and the fluorescence radiations are collinear between the third dichroic mirror and the plant tissue, and collimation of the excitation radiations and the fluorescence radiations is carried out by the same optical lenses. The collimating optical system comprises a single series of optical lenses performing collimation both of the excitation radiations and the fluorescence radiations. The fluorescence radiations and the excitation radiations are collinear between the third dichroic mirror and the tissue. It is the third dichroic mirror that has the role of directing:
the excitation radiations coming from the first dichroic mirror towards the series of lenses, and
the fluorescence radiations coming from the tissue towards the corresponding detectors.

Moreover, each emitter can comprise a filter positioned in front of this emitter. This filter has the role of cleaning-up the excitation radiation emitted by said emitter and of removing the unwanted wavelengths.

Moreover, each detector can also comprise a filter positioned in front of this detector, this filter having the role of cleaning-up the fluorescence radiation arriving at this detector and removing the unwanted wavelengths of the fluorescence radiations as well as the residual components of the excitation radiations.

Advantageously, each of the first and second detectors supplies an electrical signal, and the system comprises at least one amplifier that amplifies this electrical signal.

Moreover, when the excitation radiations are emitted in the form of time-shifted pulses, the system according to the invention can comprise at least one sampler controlled by at least one synchronizing signal so as to perform the sampling of the electrical signal supplied by the first and/or the second detector when the first and/or the second excitation radiation is emitted. The synchronizing signal can correspond to a control signal of the sources of emission of the excitation radiations. Thus, when an emitter emits an excitation radiation, the sampling means associated with this emitter sample the electrical signal supplied by the detector associated with said emitter.

Each of the first and second emitters can comprise an array of light-emitting diodes or lasers emitting the excitation radiation.

Advantageously, the system according to the invention can be positioned either in contact with or at a distance from the plant tissue to be characterized. Moreover, the distance between the system according to the invention and the plant tissue can be either fixed or variable.

Moreover, the system according to the invention can be mounted on a mobile machine for characterizing a plurality of plants in an ad hoc fashion, and more particularly the nitrogen requirement and/or the nitrogen nutrition requirement of the plants.

According to an advantageous embodiment, the system according to the invention can comprise or can be connected to means for position determination technology for performing cartography of the plants, characterized according to one or more predetermined criteria. These criteria can comprise the nitrogen requirement of the plants, the nitrogen nutrition of the plants, etc.

Other advantages and characteristics will become apparent on examination of the detailed description of an embodiment which is in no way limitative, and the attached drawings in which:

FIG. 1 is a diagrammatic representation of the principle of measurement of the ratio of the contents of chlorophyll and of a chromophorous compound in a plant tissue;

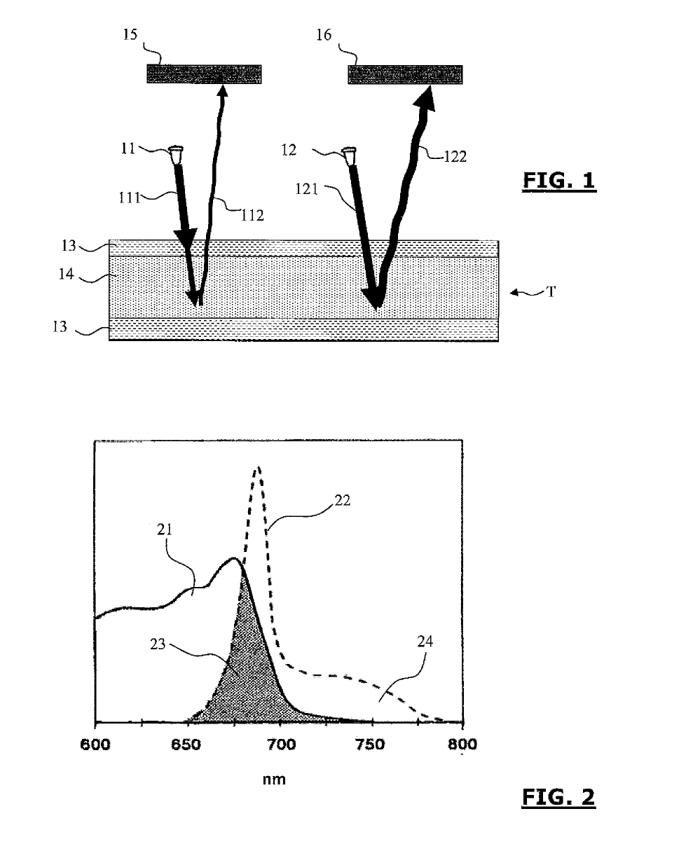

FIG. 2 is a representation of the absorption and emission spectra of chlorophyll fluorescence;

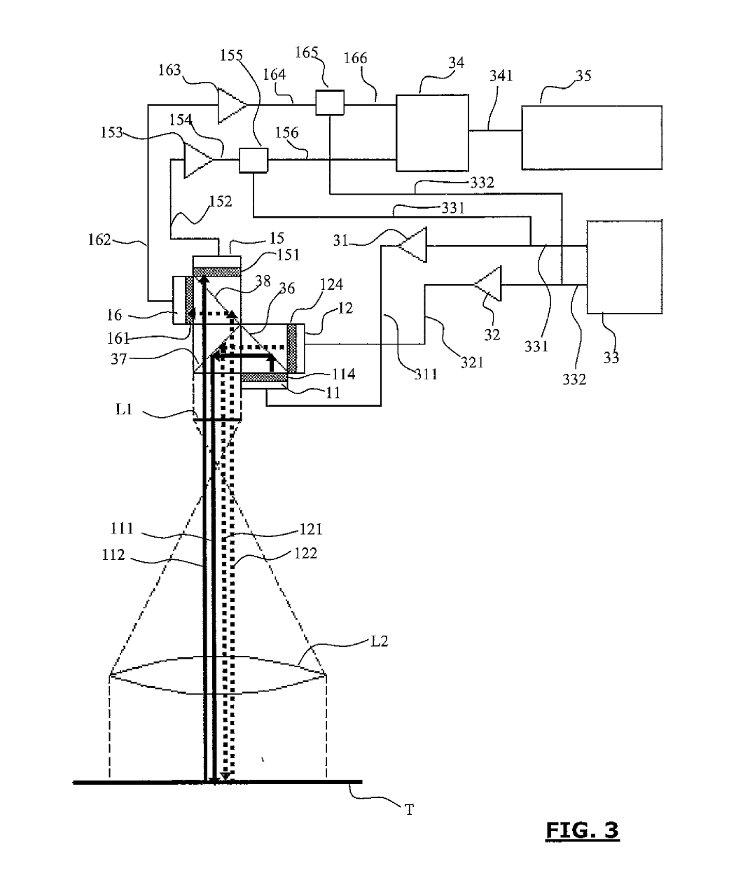

FIG. 3 is a diagrammatic representation of a first version of a first embodiment of the system according to the invention;

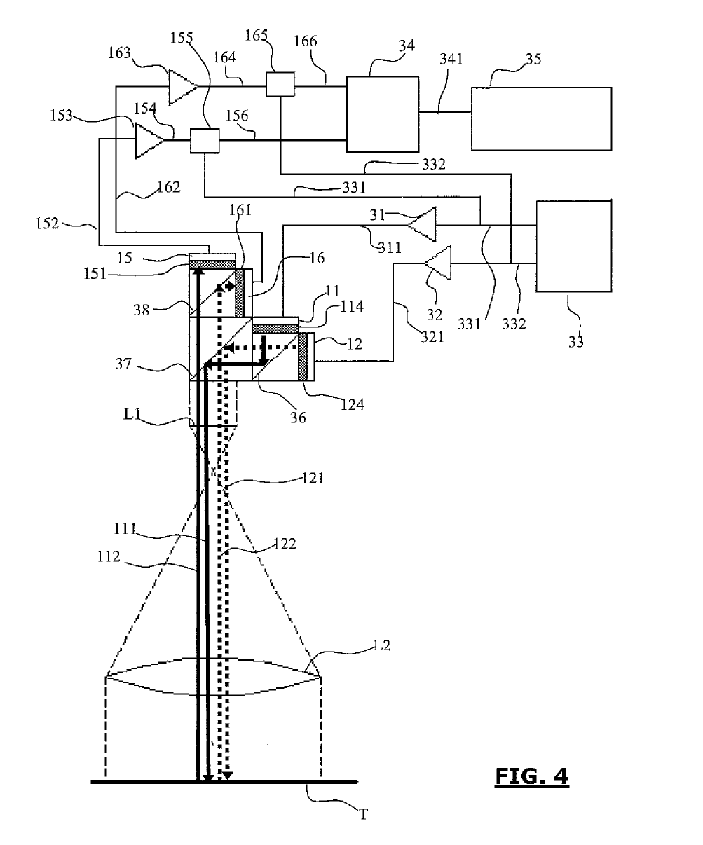

FIG. 4 is a diagrammatic representation of a second version of the first embodiment of the system according to the invention;

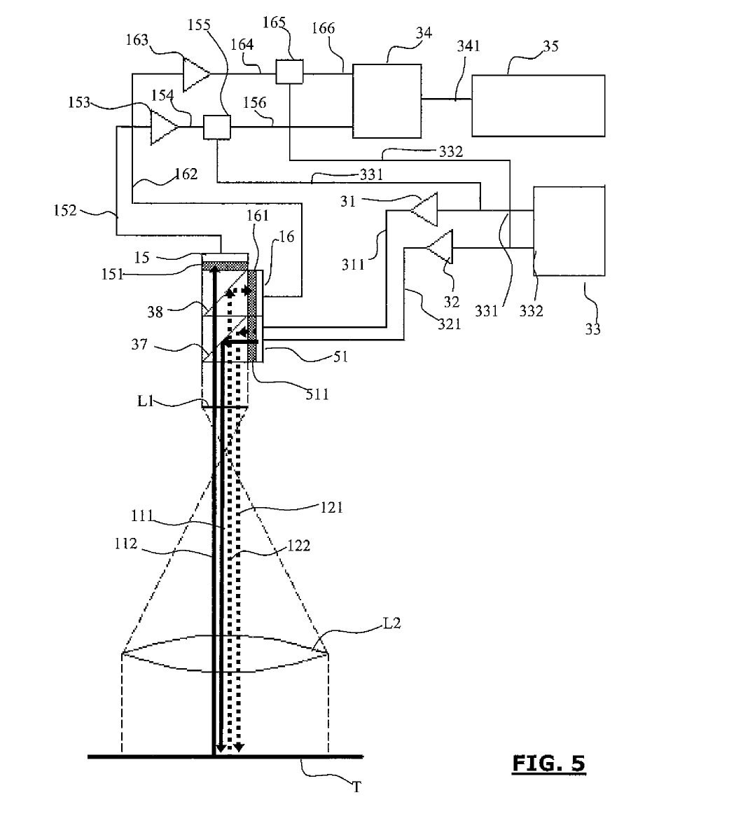

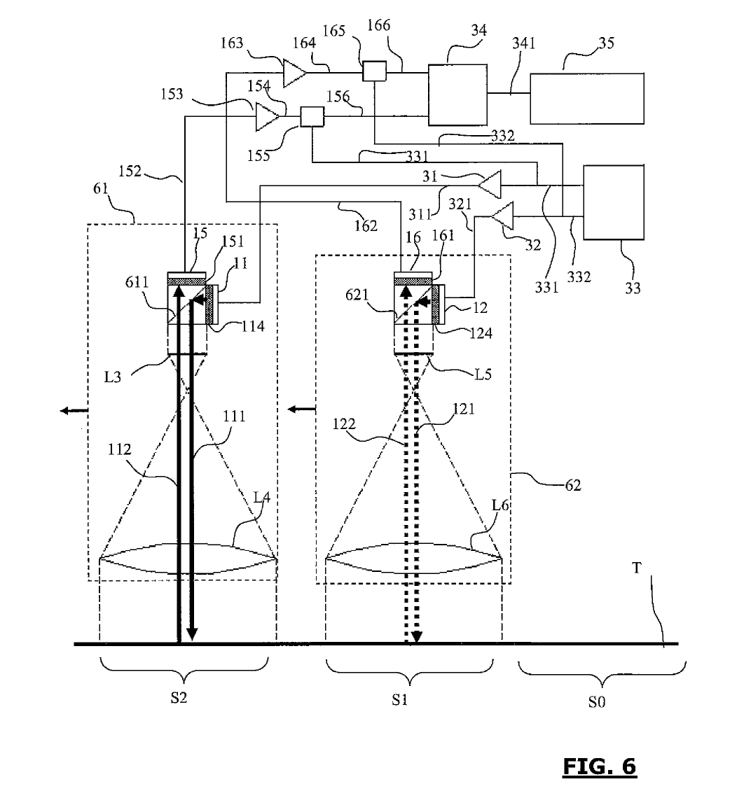

FIG. 5 is a diagrammatic representation of a third version of the first embodiment of the system according to the invention;

FIG. 6 is a diagrammatic representation of a second embodiment of the system according to the invention;

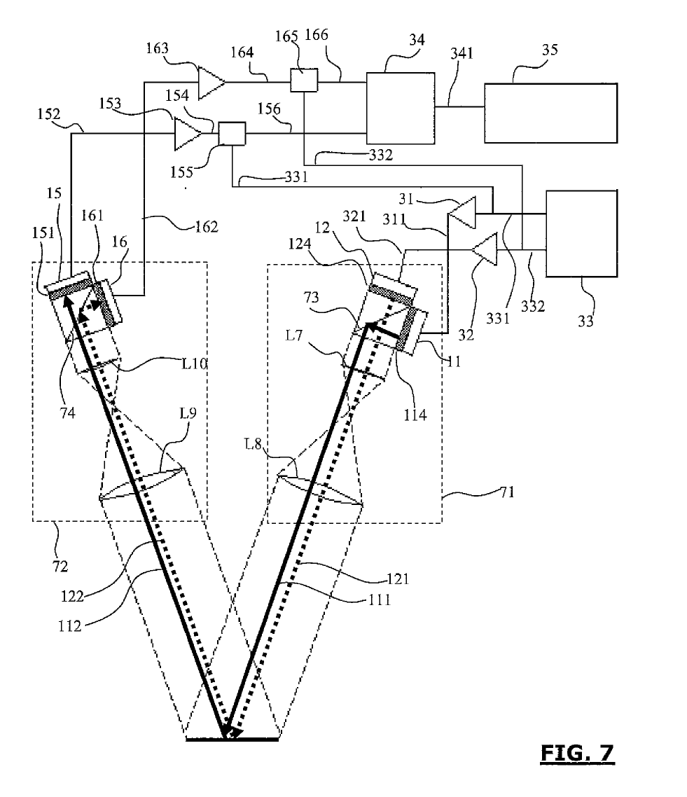

FIG. 7 is a diagrammatic representation of a third embodiment of the system according to the invention;

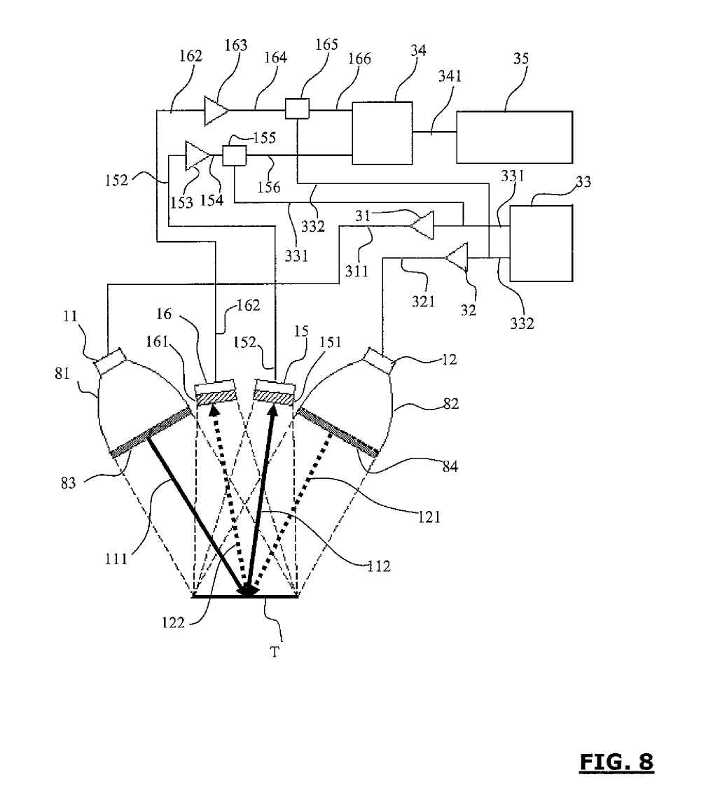

FIG. 8 is a diagrammatic representation of a fourth embodiment of the system according to the invention;

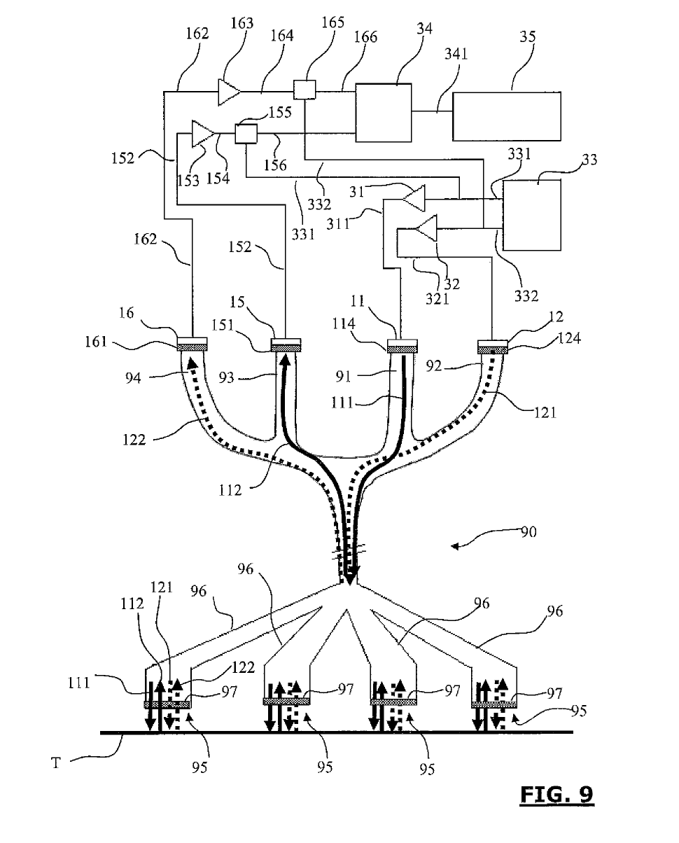

FIG. 9 is a diagrammatic representation of a fifth embodiment of the system according to the invention;

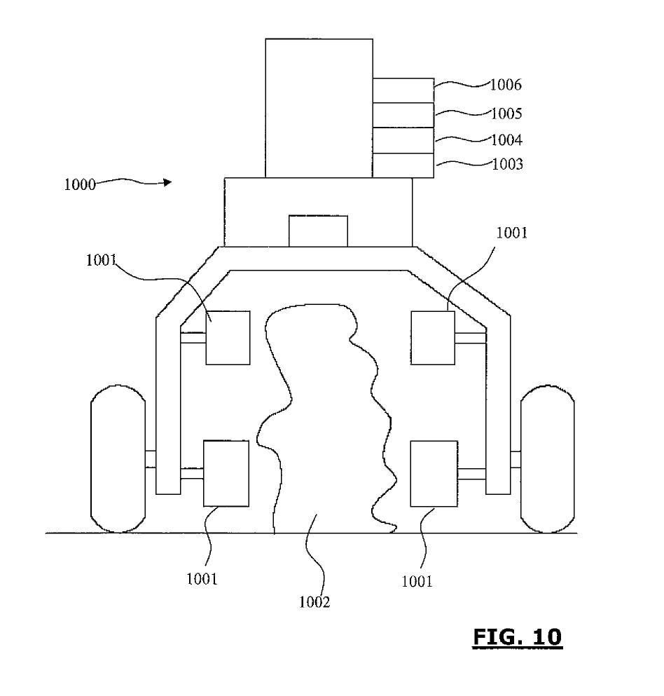

FIG. 10 is a diagrammatic representation of a mobile structure carrying a system according to the invention for measuring a large area of vegetation in an ad hoc fashion; and

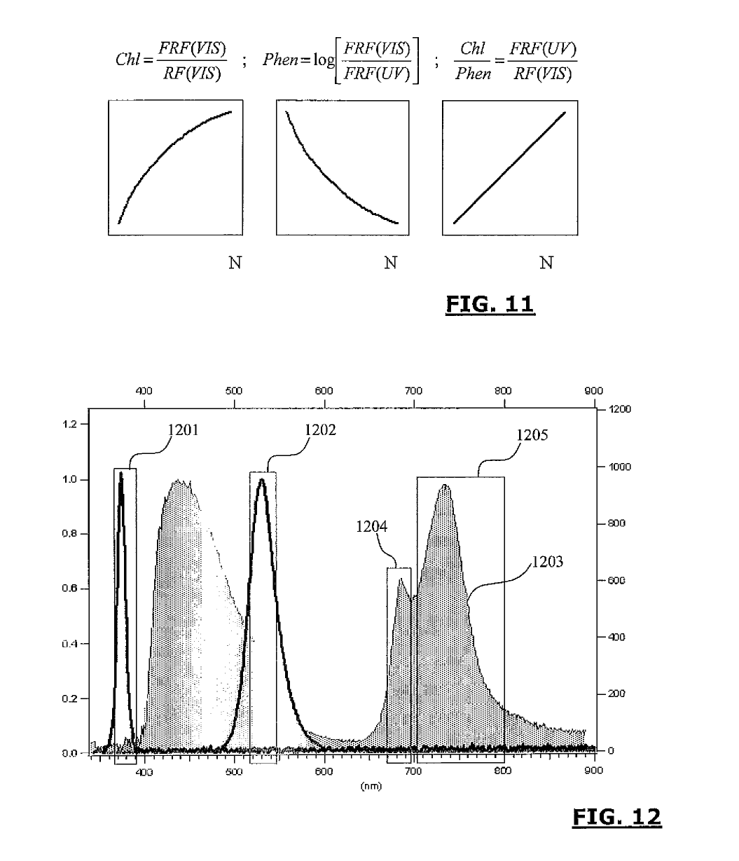

FIGS. 11 and 12 illustrate an example of application of the invention for determining the ratio of the contents of chlorophyll and of polyphenols in a plant for the purpose of monitoring the state of nitrogen nutrition of a crop.

FIG. 1 is a diagrammatic representation of the principle of measurement of the ratio of the contents of chlorophyll and of a chromophorous compound in a plant tissue. A first source (or emitter) 11 emits a first excitation radiation 111 and a second source (or emitter) 12 emits a second radiation 121. These emitters 11 and 12 are arranged in such a way that the plant tissue T receives the radiations 111 and 121. The chromophorous compound 13 is not fluorescent in the band of chlorophyll fluorescence 14.

The first excitation radiation 111 is selected so as to be partially absorbed by the chromophorous compound 13. The first excitation radiation 111 penetrates into the tissue T. A portion of this radiation 111 is absorbed by the chromophorous compound 13. The non-absorbed portion of the radiation 111 is absorbed by chlorophyll 14 and induces a first fluorescence radiation 112 of chlorophyll 14.

The second excitation radiation 121 is selected so as not to be (or very slightly) absorbed by the chromophorous compound 13. The second excitation radiation 121 penetrates into the tissue, passes almost completely through the part of the tissue occupied by the chromophorous compound 13 and reaches the chlorophyll 14. The second radiation 121 is then absorbed by the chlorophyll 14 and induces a second fluorescence radiation 122 of the chlorophyll.

The fluorescence radiations 112 and 122 are spectrally identical. These fluorescence radiations 112 and 122 have a spectrum, part of which is located outside of the absorption spectrum of chlorophyll 14 and another within the absorption spectrum of chlorophyll. The part of the fluorescence radiations 112 and 122 located in the absorption spectrum of the fluorescence 14 is partially reabsorbed by the chlorophyll 14.

A detector 15 is provided for detecting only a portion of the first fluorescence radiation 112 located outside of the absorption spectrum of chlorophyll and a detector 16 is provided for detecting only a portion of the second fluorescence radiation 122 located in the absorption spectrum of chlorophyll.

FIG. 2 gives a representation of the absorption spectrum 21 of chlorophyll 14 and of the fluorescence spectrum 22 of chlorophyll 14, hence of the spectrum of the fluorescence radiations 112 and 122. As can be seen from FIG. 2, the spectra of absorption 21 and of fluorescence of chlorophyll 14 overlap. For each fluorescence radiation 112 and 122 of chlorophyll 14, the wavelengths located in spectral band 23 are partially reabsorbed by the chlorophyll and the wavelengths located in spectral band 24 are not reabsorbed by the chlorophyll. The detector 15 is therefore provided for detecting a portion of the fluorescence radiation 112 located in spectral band 24 and detector 16 is provided for detecting a portion of the fluorescence radiation 122 located in spectral band 23.

Moreover, the fluorescence radiations 112 and 122 are of course isotropic. From a spatial standpoint, detectors 15 and 16 only receive a single portion of these radiations 112 and 122. For ease of description and representation, we shall not take account of the isotropic nature of the fluorescence radiations 112 and 122. In the rest of the description, we are only interested in the portion of each fluorescence radiation detected by detector 15 or 16.

Moreover, in the rest of the description, the spectral bands 23 and 24 will be called respectively the RF band for “red fluorescence” and FRF band for “far red fluorescence”. Thus, the portion of the first fluorescence radiation 112 detected by detector 15 will be called FRF fluorescence and the portion of the second fluorescence radiation 122 detected by detector 16 will be called RF fluorescence.

FIGS. 3 to 9 are diagrammatic representations of several embodiments of a system according to the invention. Regardless of the embodiment, the system according to the invention comprises the first source (or emitter) 11 emitting the first excitation radiation 111, and the second source (or emitter) 12 emitting the second excitation radiation 121.

The system further comprises the first detector 15 provided for detecting the FRF fluorescence induced by the first radiation 111 and the second detector 16 provided for detecting the RF fluorescence induced by the second excitation radiation 121.

In the present example, the excitation radiations 111 and 121 are emitted in the form of pulses. The sources 11 and 12 are supplied by feeds 31 and 32 controlled by a control and synchronizing module 33 supplying, to the input of each of the feeds 31 and 32, a control and synchronizing signal, 331 and 332 respectively. Each of the feeds 31 and 32 supplies a current, 311 and 321 respectively, in sources 11 and 12 as a function of the state of their input. When the input of a feed is at the high logic state, a pulse of current is sent into the source. When the input of a feed is at the low logic state, the source is switched off and no current pulse is sent. The signals 331 and 332, supplied by the control and synchronizing module 33 and present at the control input of the feeds 31 and 32 are pulses such that the sources 11 and 12 are activated alternately and not simultaneously.

A filter 151 and 161, which only allows the desired portion of the fluorescence radiations 112 and 122 to pass, is positioned in front of each detector 15 and 16. In fact, filter 151, positioned in front of detector 15, only allows the FRF portion of the first fluorescence radiation 112 to pass, and filter 161, positioned in front of detector 16, only allows the RF portion of the second fluorescence radiation 122 to pass. Of course, these filters 151 and 161 can be selected so that they only allow a portion of the FRF or RF fluorescence to pass towards the detectors 15 and 16 and/or reject the excitation wavelengths.

The detectors 15 and 16, provided for detecting the desired fluorescence, each supply an electrical quantity, 152 and 162 respectively. These electrical quantities 152, 162 are representative of the fluorescence emissions of the tissue T being analysed, i.e. the fluorescence radiations 112 measured in band 24 and 122 measured in band 23. The tissue T can be a leaf, a plant or a part of a plant, or a collection of plants. The electrical signals 152 and 162 are amplified by amplifiers, 153 and 163 respectively, which supply two amplified signals, 154 and 164 respectively. The amplified signals 154 and 164 are sampled by track-and-hold units 155 and 165. The track-and-hold units 155 and 165 are controlled by two synchronizing signals, which in the present example are the signals 331 and 332, which are also present at the input of feeds 31 and 32. The track-and-hold unit 155 samples, and puts in analogue memory, the signal 154 received from detector 15 only during start-up of source 11 and the track-and-hold unit 165 samples, and puts in analogue memory, the signal 164 received from detector 16 only during start-up of source 12. Thus the track-and-hold units 155 and 165 supply continuous quantities 156 and 166 representative of the fluorescences induced by the excitation radiations 111 and 121 respectively, in the emission bands 24 (FRF) and 23 (RF).

These quantities 156 and 166 are then converted, by an analogue-digital converter 34, to digital data 341 transmitted to a calculation and communication module 35 comprising a microcontroller, a digital memory, a display, a digital communication means such as a serial interface and a keyboard. The calculation and communication module 35 calculates the ratio between quantity 156 and quantity 166, representative of the ratio of the contents of chlorophyll and chromophorous compound in the tissue T.

Thus, the invention makes it possible to determine directly the ratio of the contents without separately determining the chlorophyll content and the content of chromophorous compound in the tissue T.

Regardless of the embodiment, the sources 11 and 12 and the detectors 15 and 16 are suitably oriented and collimated.

In the first embodiment, shown diagrammatically in FIG. 3, the excitation radiations 111 and 121 are emitted by the sources 11 and 12, associated with two filters 114 and 124 respectively, in two approximately perpendicular directions. The filters 114 and 124 are able to remove the unwanted components of the radiations 111 and 121. These radiations 111 and 121 arrive on a dichroic mirror 36 positioned at approximately 45° with respect to the directions of emission of the excitation radiations 111 and 121. The dichroic mirror 36 makes the radiations 111 and 121 collinear, allowing one of these radiations to pass, here the second excitation radiation 121, and reflecting the other one of these radiations, here the first excitation radiation 111. The collinear excitation radiations 111 and 121 then arrive on a second dichroic mirror 37, which reflects the excitation radiations towards the tissue T. The excitation radiations 111 and 121 reflected by the dichroic mirror towards the tissue T are then collimated on the tissue T by two lenses L1 and L2. The excitation radiations 111 and 121 are still collinear. The fluorescence radiations 112 and 122 induced by the excitation radiations 111 and 121 are collimated by lenses L2 and L1 on the dichroic mirror 37. The latter allows these radiations 112 and 122 to pass towards a third dichroic mirror 38 arranged at approximately 45° with respect to the detectors 15 and 16. This dichroic mirror allows the FRF portion of the radiation 112 to pass towards detector 15 and reflects the RF portion of the fluorescence radiation 122 towards detector 16.

FIG. 4 presents a second version of the first embodiment shown in FIG. 3. In this second version the detectors 15 and 16 and the emitters 11 and 12 are positioned according to an arrangement that is different from the first version.

FIG. 5 is a third version of the first embodiment shown in FIGS. 3 and 4. In this version the excitation radiations 111 and 121 are emitted in a collinear manner and advantageously by one and the same source 51, which can emit both the first excitation radiation 111 and the second excitation radiation 121, such as an array of diodes that can emit several radiations of different wavelengths. Such a source can for example be an array of three-colour diodes RGB (Red-Green-Blue). As the excitation radiations 111 and 121 are emitted in a collinear manner by the source 51, the dichroic mirror 36 is not needed in this third version of the first embodiment. One or more filters 511 can be positioned in front of the source 51 to remove the unwanted components of the excitation radiations 111 and 121 emitted by the source 51.

In the first embodiment, three versions of which are shown in FIGS. 3, 4 and 5, the excitation radiations 111 and 121 are collinear with the fluorescence radiations 112 and 122 between the dichroic mirror 37 and the tissue T. Moreover, the collimation of the excitation radiations 111 and 121 on the tissue T and the collimation of the fluorescence radiations on the dichroic mirror 37 are carried out by the same lenses L1 and L2.

FIG. 6 is a diagrammatic representation of a second embodiment of the system according to the invention. In this embodiment the emitter 11 and detector 15 form a first assembly 61 comprising moreover filters 114 and 151 as well as two lenses L3 and L4 performing collimation of the first excitation radiation 111 on the tissue T and collimation of the first fluorescence radiation 112 towards a dichroic mirror 611. The excitation radiation 111, emitted by emitter 11, is reflected by the dichroic mirror 611 towards the tissue T. The lenses L3 and L4 then perform the collimation of the first excitation radiation 111 on the tissue T. The first fluorescence radiation 112, induced by the first excitation radiation 111, is collimated by lenses L3 and L4 towards the dichroic mirror 611. This dichroic mirror allows the first fluorescence radiation 112 to pass towards detector 15, in front of which filter 151 is positioned. The emitter 12 and detector 16 form a second assembly 62 comprising moreover filters 124 and 161 as well as two lenses L5 and L6 performing collimation of the second excitation radiation 121 on the tissue T and collimation of the second fluorescence radiation 122 towards a dichroic mirror 621. The excitation radiation 121, emitted by the emitter 12, is reflected by the dichroic mirror 621 towards the tissue T. The lenses L5 and L6 then perform the collimation of the second excitation radiation 121 on the tissue T. The second fluorescence radiation 122, induced by the second excitation radiation 121, is collimated by lenses L5 and L6 towards the dichroic mirror 621. This dichroic mirror 621 allows the second fluorescence radiation 122 to pass towards detector 16, in front of which filter 161 is positioned.

The assemblies 61 and 62 are mobile and follow one another. Thus, at time t, assembly 61 is positioned towards a surface 51 of the tissue T and assembly 62 is positioned towards a surface S0 of the tissue T. A first measurement is carried out. Then, at time t+1, assembly 61 moves and is positioned towards a surface S2 of the tissue T and assembly 62 is positioned towards the surface S1. A second measurement is carried out. The ratio of the contents of chlorophyll and of a chromophorous compound of the surface S1 is determined using the measurement carried out by assembly 61 at time t and the measurement carried out by assembly 62 at time t+1.

FIG. 7 is a diagrammatic representation of a third embodiment in which the emitters 11 and 12 form a first assembly 71 comprising moreover the filters 114 and 124, a dichroic mirror 73 as well as collimating lenses L7 and L8. The detectors 15 and 16 form a second assembly 72 comprising moreover the filters 151 and 161, a dichroic mirror 74 as well as two collimating lenses L9 and L10. In this third embodiment the sources 11 and 12 are arranged approximately perpendicularly. The excitation radiations 111 and 121 are emitted by the sources 11 and 12 in two approximately perpendicular directions. These radiations 111 and 121 arrive on a dichroic mirror 73 positioned at approximately 45° with respect to the directions of emission of the excitation radiations 111 and 121. The dichroic mirror 73 makes the radiations 111 and 121 collinear, allowing one of these radiations, here the radiation 121, to pass and reflecting the other one of these radiations, here the radiation 111. These collinear radiations are then collimated on the tissue T by lenses L7 and L8.

The fluorescence radiations 112 and 122, induced by radiations 111 and 121, are collimated towards a dichroic mirror 74 by a second series of two lenses L9 and L10. The dichroic mirror 74 reflects the RF portion of the second fluorescence radiation 122, and transmits the FRF portion of the first fluorescence radiation 112.

The dichroic mirrors used in the embodiments described above are high-pass dichroic mirrors (with respect to wavelength) suitably selected according to the wavelengths of the various excitation and fluorescence radiations.

FIG. 8 is a diagrammatic representation of a fourth embodiment of the system according to the invention without dichroic mirrors. In this fourth embodiment, the collimation of the emitters 11 and 12 is carried out by parabolic or quasi-parabolic reflectors 81 and 82 arranged in front of the emitters 11 and 12. Filters 83 and 84 are arranged in front of the reflectors to remove the unwanted components of the excitation radiations 111 and 121.

FIG. 9 is a diagrammatic representation of a fifth embodiment of the system according to the invention. In this fifth embodiment, the system according to the invention comprises a device 90 for guiding optical radiations, for example an assembly of optical fibres. The optical fibres are distributed from four openings 91-94 to a plurality of ends 95. The emitters 11 and 12 and the detectors 15 and 16 together with their filters, 114, 124, 151 and 161 respectively are arranged in front of the openings 91, 92, 93 and 94 respectively. The excitation radiations 111 and 121 are conveyed by the optical fibres from the openings 91 and 92 to the ends 95 of device 90 through a plurality of branches 96. At each end 95, the excitation radiations 111 and 121 are sent towards the tissue T. The fluorescence radiations induced 112 and 122 are collected by the optical fibres and conveyed to the detectors 15 and 16 arranged in front of the openings 93 and 94. Each end 95 of the device 90 comprises a collecting lens 97.

This embodiment has the advantage that it is possible to move the emitters 11 and 12 as well as the detectors 15 and 16. Moreover, the excitation radiations 111, 121 and the fluorescence radiations 112 and 122 are collinear. The system according to the invention is more robust. The ends 95 of device 90 make it possible to carry out multipoint measurements on tissues of considerable length.

As shown diagrammatically in FIG. 10, the system according to the invention can be of a size and shape intended for mounting on a structure 1000. The structure 1000 shown in FIG. 10 comprises four systems according to the invention 1001. The structure 1000 can be of shape and dimensions intended to be pulled by a vehicle along a large area of plants, for example for continuous monitoring and analysis of a row of vines 1002, on several levels and on both sides.

The systems according to the invention 1001 can incorporate, or communicate with, one or more computerized means, such as position determination technology means 1003 making it possible to carry out cartography according to the measurement results or according to a particular treatment carried out on the plant surface or means of control of the measurements 1004, or control means 1005 for a processing carried out as and when needed, or means of communication 1006 with one or more other systems.

Other embodiments can be produced based on different types of vehicles brought in to cover the area to be treated or evaluated, for example on a lawnmower, or on an individual cart for transporting golf clubs.

An example of application of the invention will now be described, with reference to FIGS. 11 and 12. In the example of application that we are going to describe, the chromophorous compound is a polyphenol. In this example the required ratio NBI (Nitrogen Balance Index) is the ratio:

$$NBI = \frac{Chlorophyll ( CHL )}{Polyphenols ( PHEN )}$$

of a plant. As described above, this ratio is a very good indicator of the nitrogen nutrition of a plant. It can be used for monitoring the state of nitrogen nutrition of plants over a large area. It can constitute a criterion for performing, by means of the system according to the invention, cartography of the nitrogen nutrition of plants. Moreover, it can be used for treating plants, for example for supplying a nitrogen supplement to plants.

FIG. 11 shows the variation of the chlorophyll content Chl, of the polyphenols content Phen and of the ratio of these contents as a function of nitrogen nutrition N. Each of these contents can be measured independently by measurement of fluorescence using a first excitation radiation in the ultraviolet (UV), absorbed by the polyphenols, and a second excitation radiation in the visible range (VIS), not absorbed by the polyphenols. This will give:

$$Chl = \frac{FRF ( VIS )}{RF ( VIS )} ; Phen = log [ \frac{FRF ( VIS )}{FRF ( UV )} ] ; \frac{Chl}{Phen} = \frac{FRF ( UV )}{RF ( VIS )}$$

The system used within the scope of this particular example of application can be a system implemented according to any one of the embodiments described above. It can even be implemented according to any combination of the embodiments described above.

The first excitation radiation 111 emitted by the source 11 is ultraviolet radiation (UV), at a wavelength or a set of wavelengths absorbed by the polyphenols of the leaf, for example 375 nm. An example of such a source 11 is an array of light-emitting diodes such as OTLH-0280-UV (Opto Technology, IL, USA) preferably combined with an optical filter 114 such as DUG11 (Schott, Germany) which blocks the visible wavelengths and allows the ultraviolet wavelengths to pass. This ultraviolet radiation at 375 nm induces a first fluorescence radiation 112, only a portion of which, located in the far red, FRF(UV), centred around 740 nm, and not absorbed by the chlorophyll, will be measured. The detector 15 combined with filter 151 is only sensitive to the long wavelengths of the emission spectrum of chlorophyll fluorescence, i.e. wavelengths greater than 700 nm. An example of such a detector 15 is a silicon photodiode such as PDB-C618 (Advanced Photonix Inc, USA) combined with an optical filter 151 such as RG9 from Schott (Germany).

The second excitation radiation 121 emitted by source 12 is radiation in the visible range (VIS), at a wavelength or a set of wavelengths not absorbed by the polyphenols, for example at 530 nm. An example of such a source 12 is the array of light-emitting diodes OTLH-0020-GN (Opto Technology, Inc, IL, USA) emitting at 530 nm, preferably combined with an optical filter 124 for the purpose of cutting off all stray emission which would coincide with the spectral sensitivity band of detector 16. The visible radiation (VIS) induces a second fluorescence radiation 122 of the chlorophyll. This second fluorescence radiation 122 has an emission band 23 in the red, RF(VIS), in the absorption spectrum of chlorophyll and will therefore be partially reabsorbed by the chlorophyll. The non-reabsorbed portion of the fluorescence radiation in band 23 will be measured by detector 16 combined with filter 161. It corresponds to the short wavelengths of the emission spectrum of chlorophyll fluorescence, i.e. the wavelengths near the peak emission at 685 nm. Detector 16 combined with filter 161 is therefore only sensitive to the short wavelengths of the emission spectrum of chlorophyll fluorescence. Such a detector 16 can be a silicon photodiode, in front of which a suitable filter 161 is placed, such as an interference filter centred on 685 nm. FIG. 12 shows a representation of the spectrum 1201 of the first excitation radiation 111, the spectrum 1202 of the second excitation radiation 121, the spectrum 1203 of chlorophyll fluorescence, the spectrum 1205 of FRF(UV) fluorescence measured by detector 15 and the spectrum 1204 of RF(VIS) fluorescence measured by detector 16.

The NBI ratio is then calculated according to the following formula:

$$NBI = \frac{FRF ( UV )}{RF ( VIS )} .$$

Other forms of modulation of the excitation radiations 111 and 121 can be envisaged. The radiations 111 and 121 can for example be modulated sinusoidally at different frequencies, radiation 111 being modulated at a frequency f1 and radiation 121 at a frequency f2. The signal 132 from detector 13 will be filtered at the frequency f1 of modulation of radiation 111 whereas the signal 142 from detector 14 will be filtered at the frequency f2 of modulation of radiation 121.

The invention is not limited to the examples of application described above. The arrangement of the sources and detectors, the type of source and detector used, the collimating optical system, and the modulation of the various radiations can be changed while remaining within the scope of the invention.

1-25. (canceled)

26. Method for determining the ratio of the contents of chlorophyll (14) and of a chromophorous compound (13) in a plant tissue (T), said chromophorous compound (13) not being fluorescent in the fluorescence band (22) of chlorophyll (14), said method comprising the following operations:
emission, by a first emitter (11) in the direction of said plant tissue (T), of optical radiation, called the first excitation radiation (111), selected so as to be absorbed partially by the chromophorous compound (13) and to induce a first fluorescence radiation (112) of the chlorophyll (14),
detection, by a first detector (15), of a portion of said first fluorescence radiation (112) located outside of the absorption spectrum (21) of the chlorophyll (14),
emission, by a second emitter (12) in the direction of said plant tissue (T), of optical radiation, called the second excitation radiation (121), selected so as not to be absorbed by the chromophorous compound (13) and to induce a second fluorescence radiation (122) of the chlorophyll (14),
detection, by a second detector (16), of a portion of said second fluorescence radiation (122) located in the absorption spectrum (21) of the chlorophyll (14), and
determination of said ratio from the ratio of said fluorescence radiations that were detected.

27. Method according to claim 26, characterized in that each of the detectors (15, 16) supplies an electrical signal (152, 162), said method comprising moreover sampling, by sampling means (155, 165), of the electrical signal (152, 162) supplied by each detector (15, 16).

28. Method according to claim 26, characterized in that the first and second excitation radiations (111, 121) are emitted in the form of pulses non-simultaneously, said method further comprising synchronization of the emitters (11, 12) and the sampling means (155, 165) in such a way that the sampling of the electrical signal (152, 162) supplied by the first and/or the second detector (15, 16) is carried out when the first and/or the second emitter (11, 12) emits a pulse.

29. Method according to claim 26, characterized in that the first and second excitation radiations (111, 121) are modulated at two different frequencies.

30. Method according to claim 26, characterized in that it is applied on a plant entity selected from the following list:
a plant leaf,
a tissue from a plant,
a part of a plant, and
a collection of plants.

31. Method according to claim 26, characterized in that:
the chromophorous compound is a polyphenol and the wavelength of the first excitation radiation (111) is between 300 and 500 nm; and
the wavelength of the second excitation radiation (121) is between 500 and 700 nm.

32. Method according to claim 31, characterized in that it comprises determination of the nitrogen nutrition requirement of said tissue (T) from the ratio of the fluorescence radiations detected.

33. System for determining the ratio of the contents of chlorophyll (14) and of a chromophorous compound (13) in a plant tissue (T), said chromophorous compound (13) not being fluorescent in the fluorescence band (22) of the chlorophyll (14), said system comprising:
a first emitter (11) emitting, in the direction of said tissue (T), optical radiation, called the first excitation radiation (111), selected so as to be absorbed partially by the chromophorous compound (13) and to induce a first fluorescence radiation (112) of the chlorophyll (14),
a first detector (15) performing the detection of a portion of said first fluorescence radiation (112) located outside of the absorption spectrum (21) of the chlorophyll (14),
a second emitter (12) emitting, in the direction of said tissue (T), optical radiation, called the second excitation radiation (121), selected so as not to be absorbed by the chromophorous compound (13) and to induce a second fluorescence radiation (122) of the chlorophyll (14),
a second detector (16) performing the detection of a portion of said second fluorescence radiation (122) located in the absorption spectrum (21) of the chlorophyll (14), and
calculation means (18, 19) for determining said ratio from the ratio of said fluorescence radiations detected.

34. System according to claim 33, characterized in that it comprises a collimating optical system performing collimation of the first and the second excitation radiation (111, 121) towards the tissue (T) and collimation of the first fluorescence radiation (112) towards the first detector (15) and collimation of the second fluorescence radiation (122) towards the second detector (16).

35. System according to claim 34, characterized in that the collimating optical system comprises:
a first dichroic mirror (36) receiving the first and the second excitation radiation (111, 121), emitted respectively by the first and the second emitter (11, 12), in two approximately perpendicular directions and making said first and second excitation radiations (111, 121) collinear,
a second dichroic mirror (38) receiving the first and the second fluorescence radiation (112, 122) coming from the plant tissue (T) in a collinear manner and directing the first and the second fluorescence radiation (112, 122) respectively onto the first detector (15) and the second detector (16) in two approximately perpendicular directions, and
optical lenses (L7, L8; L9, L10) performing collimation of the excitation radiations (111, 121) and collimation of the fluorescence radiations (112, 122) coming from the tissue (T).

36. System according to claim 35, characterized in that the collimating optical system comprises a third dichroic mirror (37) performing:
reflection, towards the plant tissue (T), of the collinear excitation radiations (111, 121) coming from the first dichroic mirror (36), and
transmission, towards the second dichroic mirror (38), of the collinear fluorescence radiations (112, 122) coming from the plant tissue (T);
said excitation radiations (111, 121) and said fluorescence radiations (112, 122) being collinear between said third dichroic mirror (37) and said plant tissue (T), and the collimation of said excitation radiations (111, 121) and said fluorescence radiations (112, 122) being performed by the same optical lenses (L1, L2).

37. System according to claim 33, characterized in that:
each emitter (11, 12) comprises a filter (114, 124) positioned in front of said emitter (11, 12), and said filter (114, 124) cleans up the excitation radiation (111, 121) emitted by said emitter (11, 12), and/or
each detector (15, 16) comprises a filter (151, 161) positioned in front of said detector (15, 16), and said filter (151, 161) removes the unwanted components of the fluorescence radiation (112, 122) arriving at said detector (15, 16).

38. System according to claim 33, characterized in that each of the first and second detectors (15, 16) supplies an electrical signal (152, 162), said system comprising at least one amplifier (153, 163) that amplifies said electrical signal (152, 162), said system also comprising at least one sampler (155, 165) controlled by a synchronizing signal (331, 332) so as to perform the sampling of the electrical signal (154, 164) supplied by the first and/or the second detector (15, 16) when the first and/or the second excitation radiation (111, 121) is emitted.

39. System according to claim 33, characterized in that the first emitter (11) and/or the second emitter (12) comprises an array of light-emitting diodes.

40. System according to claim 33, characterized in that it is mounted on a mobile machine (1000) for characterizing a plurality of plants in an ad hoc fashion, said system also comprising means for position determination technology (1003).

41. Method according to claim 27, characterized in that the first and second excitation radiations (111, 121) are emitted in the form of pulses non-simultaneously, said method further comprising synchronization of the emitters (11, 12) and the sampling means (155, 165) in such a way that the sampling of the electrical signal (152, 162) supplied by the first and/or the second detector (15, 16) is carried out when the first and/or the second emitter (11, 12) emits a pulse.

42. Method according to claim 27, characterized in that the first and second excitation radiations (111, 121) are modulated at two different frequencies.

43. Method according to claim 30, characterized in that it comprises determination of the nitrogen nutrition requirement of said tissue (T) from the ratio of the fluorescence radiations detected.
